(19) United States
(12) Patent Application Publication
(10) Pub. No.: US 2024/0375410 A1
(43) Pub. Date: Nov. 14, 2024

(54) INK EJECTION INSPECTION DEVICE, INK EJECTION INSPECTION METHOD, NON-TRANSITORY RECORDING MEDIUM STORING COMPUTER-READABLE INK EJECTION INSPECTION PROGRAM, INK EJECTION DEVICE, AND IMAGE FORMING APPARATUS

(71) Applicant: Konica Minolta, Inc., Tokyo (JP)

(72) Inventor: Yasunori INABA, Tokyo (JP)

(21) Appl. No.: 18/659,562

(22) Filed: May 9, 2024

(30) Foreign Application Priority Data
May 11, 2023 (JP) 2023-078615

(51) Int. Cl. B41J 2/21; G01V 8/10; H04N 1/00

(52) U.S. Cl. CPC B41J 2/2142; B41J 2/2135; G01V 8/10; H04N 1/00795; H04N 2201/0081

(57) ABSTRACT

An ink ejection inspection device can determine a state of ejection of ink from each of nozzles with high accuracy. An ink ejection inspection device for inspecting a state of ejection of ink from a plurality of nozzles provided in an ink ejection device includes a hardware processor that determines the state of ejection of ink from each of the nozzles by comparing a feature value indicated by a waveform of residual vibration obtained by applying a voltage to each of the nozzles with a determination threshold set for each of the nozzles.

### CROSS-REFERENCE TO RELATED APPLICATION

The present invention claims priority under 35 U.S.C. § 119 to Japanese patent Application No. 2023-078615, filed on May 11, 2023, the entire content of which is incorporated herein by reference.

### BACKGROUND OF THE INVENTION

### 1. Technical Field

The present invention relates to an ink ejection inspection device, an ink ejection inspection method, a non-transitory recording medium storing a computer-readable ink ejection inspection program, an ink ejection device, and an image forming apparatus.

### 2. Description of Related Art

An inkjet type image forming apparatus includes an ink ejection device. The ink ejection device ejects ink droplets from nozzles by driving piezoelectric elements provided in the nozzles by drive elements. The ink ejection device can detect a defective nozzle in which an ejection failure occurs, based on residual vibration that occurs when a drive voltage is applied to a drive element. Various methods have been proposed for detecting a defective nozzle. For example, Japanese Unexamined Patent Publication No. 2013-233704 describes that “based on a first detection signal obtained by combining residual vibrations after driving a plurality of drive elements corresponding to a plurality of inspection target nozzles, a threshold to be used to determine a second detection signal (residual vibration) obtained by driving the drive element corresponding to one inspection target nozzle is corrected”. Japanese Unexamined Patent Publication No. 2013-233704 describes that, thus, the threshold can be corrected according to the ambient temperature and aging, and the states of the nozzles (head) can be inspected more accurately.

### SUMMARY OF THE INVENTION

However, the capacities of the nozzles that eject ink vary, and the elastic modulus, wiring impedance, and the like of piezoelectric elements provided in the nozzles also vary. For this reason, in the technology described in Japanese Unexamined Patent Publication No. 2013-233704 in which the threshold to be used to determine the inspection target nozzles is commonly used for all the inspection target nozzles, it is not possible to perform the determination with high accuracy in consideration of these variations occurring for each inspection target nozzle.

Therefore, an object of the present invention is to provide an ink ejection inspection device, an ink ejection inspection method, and an ink ejection inspection program that can determine a state of ejection of ink from each nozzle with high accuracy. It is a further object of the present invention to provide an ink ejection device and an image forming apparatus that are capable of forming an image by ink ejection controlled with high precision.

In order to achieve such objects, the present invention provides an ink ejection inspection device for inspecting a state of ejection of ink from a plurality of nozzles provided in an ink ejection device. The ink ejection inspection device includes a hardware processor. The hardware processor determines the state of ejection of ink from each of the nozzles by comparing a feature value indicated by a waveform of residual vibration obtained by applying a voltage to each of the nozzles with a determination threshold set for each of the nozzles.

### BRIEF DESCRIPTION OF THE DRAWINGS

The advantages and features provided by one or more embodiments of the invention will become more fully understand from the detailed description given hereinbelow and the appended drawings which are given by way of illustration only, and thus are not intended as a definition of the limits of the present invention.

FIG. 1 is a schematic configuration diagram of an image forming apparatus according to an embodiment;

FIG. 2 is a bottom view of each head unit included in an ink ejection device of the image forming apparatus according to the embodiment;

FIG. 3 is a block diagram of essential parts of the image forming apparatus according to the embodiment;

FIG. 4 is a diagram illustrating a reverberant waveform generated in a case where a pulse wave is applied to an ink chamber having a nozzle;

FIG. 5 is a flowchart (part 1) illustrating an ink ejection inspection method according to the embodiment; and

FIG. 6 is a flowchart (part 2)) illustrating the ink ejection inspection method according to the embodiment.

### DETAILED DESCRIPTION

Hereinafter, one or more embodiments of the present invention will be described with reference to the drawings. However, the scope of the invention is not limited to the disclosed embodiments.

Hereinafter, embodiments of an ink ejection inspection device, an ink ejection inspection method, an ink ejection inspection program, an ink ejection device, and an image forming apparatus to which the present invention is applied will be described in detail with reference to the accompanying drawings.

### <<Image Forming Apparatus>>

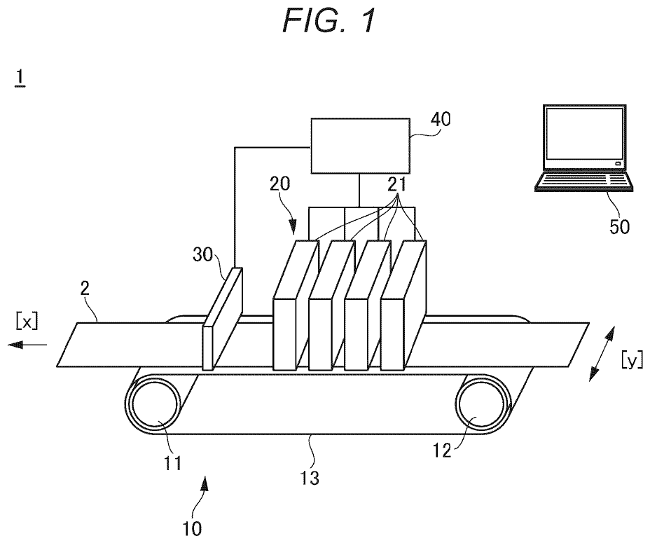

FIG. 1 is a schematic configuration diagram of an image forming apparatus 1 according to an embodiment. The image forming apparatus 1 illustrated in FIG. 1 is an inkjet apparatus for forming an ink image on a main surface of a recording medium 2. The recording medium 2 has a sheet shape and may be a single sheet or a continuous sheet. In addition, as the recording medium 2, various materials such as a cloth material such as fabric, plain paper, thick paper, thin paper, Japanese paper, special paper, corrugated paper, a resin film, and a building material may be used.

The image forming apparatus 1 includes a medium conveyance device 10, an ink ejection device 20, an image reading device 30, an ink ejection inspection device 40, and a manipulator 50. Next, these constituent elements will be described in detail.

### <Medium Conveyance Device 10>

The medium conveyance device 10 is configured by winding an endless belt 13 around a plurality of conveyance rollers 11 and 12. One of the plurality of conveyance rollers 11 and 12 is a driving roller and rotates the endless belt 13. The belt 13 has an outer peripheral surface having attraction properties, and holds the sheet-like recording medium 2 on an upper portion of the outer peripheral surface. Thus, the medium conveyance device 10 is configured to convey the recording medium 2 held on the belt 13 in a conveyance direction [x] following the rotation of the belt 13.

### <Ink Ejection Device 20>

The ink ejection device 20 includes a plurality of head units 21 that eject ink onto the recording medium 2 held by the medium conveyance device 10. These head units 21 are arranged over a conveyance width direction [y] perpendicular to the conveyance direction [x] of the recording medium 2, and eject ink over the conveyance width direction [y] of the recording medium 2.

Each of the head units 21 is provided corresponding to a respective ink color. The head units 21 of the respective colors are arranged in an arbitrarily set color order along the conveyance direction [x].

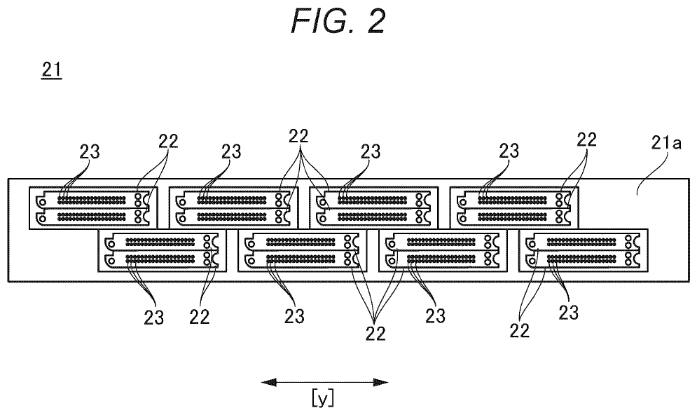

FIG. 2 is a bottom view of each head unit 21 included in the ink ejection device of the image forming apparatus according to the embodiment and is a view of one of the head units 21 illustrated in FIG. 1 from the medium conveyance device 10 side. In each of the head units 21 illustrated in FIG. 1 and FIG. 2, a plurality of ink heads 22 are arranged along an ink ejection face 21a facing the medium conveyance device 10. In the example illustrated, two ink heads 22 are set as one set, and a plurality of sets (here, eight sets) of the ink heads 22 are arranged in two rows in a staggered manner. In each of the ink heads 22 of each of the head units 21, ink ejection openings of a plurality of nozzles 23 are arranged in a surface present at the ink ejection face 21a of the head unit 21.

Each of the nozzles 23 has an ink chamber for storing ink and an ejection opening for ejecting ink. Of these, the ink chamber has a structure in which a head chip is disposed on a bottom surface. As the head chip, a piezoelectric head chip having a piezoelectric element as a driving source for ejecting ink droplets is used.

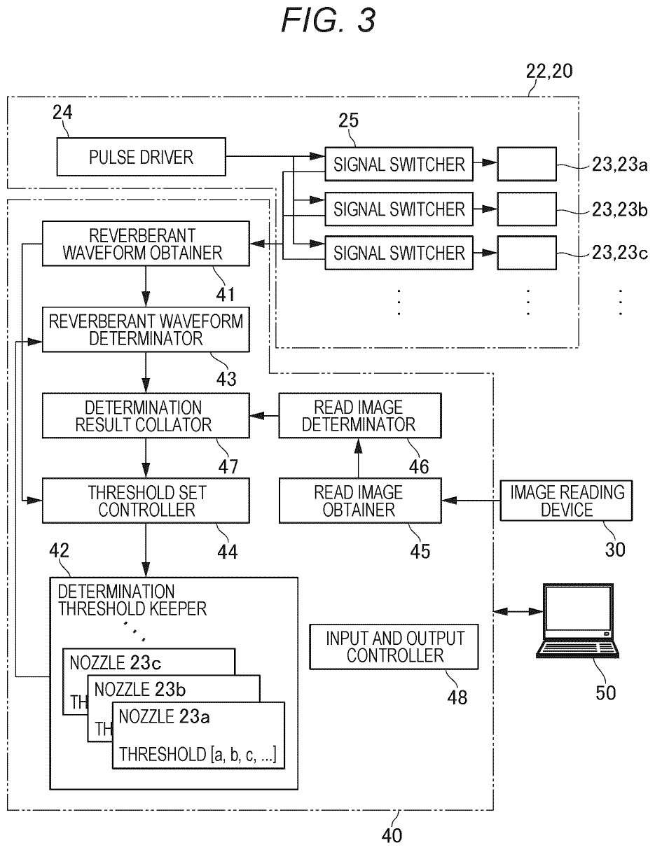

FIG. 3 is a block diagram of essential parts of the image forming apparatus 1 according to the embodiment. As illustrated in FIG. 3, each of the ink heads 22 of the ink ejection device 20 applies a drive voltage (pulse wave) applied by a pulse driver 24 as a drive element to each nozzle 23 at each timing by switching in a signal switcher 25. Thus, the nozzles 23 eject ink at their respective timings to cause the ink to land on the recording medium 2 (see FIG. 1) being conveyed by the medium conveyance device 10, thereby forming an image on the recording medium 2.

### <Image Reading Device 30>

Returning to FIG. 1, the image reading device 30 is disposed facing the recording medium 2 conveyed by the medium conveyance device 10 on the downstream side in the conveyance direction [x] with respect to the ink ejection device 20.

The image reading device 30 is, for example, a line sensor in which imaging elements are arranged in a line in the conveyance width direction [y], and images the surface of the recording medium 2 that has passed through an arrangement section of the head units 21. Further, the image reading device 30 may be a device in which imaging elements are two dimensionally arranged.

### <Ink Ejection Inspection Device 40>

The ink ejection inspection device 40 determines the state of ejection of ink from each of the nozzles 23 (refer to FIG. 2) of the ink ejection device 20. The ink ejection inspection device 40 includes a hardware processor, for example, a computing machine. The computing machine is hardware used as a so-called computer. The computing machine includes a central processing unit (CPU) and storage devices such as a read only memory (ROM) and a random access memory (RAM). Furthermore, the computing machine includes a nonvolatile storage section and a network interface.

The ink ejection inspection device 40 may be incorporated in a controller of the ink ejection device 20 and provided as a part of the ink ejection device 20.

As illustrated in FIG. 3, the ink ejection inspection device 40 includes a reverberant waveform obtainer 41, a determination threshold keeper 42, a reverberant waveform determinator 43, a threshold set controller 44, a read image obtainer 45, a read image determinator 46, a determination result collator 47, and an input and output controller 48. These functional elements are executed by an ink ejection inspection program stored in the ROM included in the ink ejection inspection device 40, or the ink ejection inspection program loaded and stored in the RAM or the storage unit from the manipulator 50 or another external device. This computer-readable ink ejection inspection program can be configured to be saved in a non-transitory recording medium, such as a ROM, a hard disk, or an optical disc, in the ink ejection inspection device 40, the manipulator 50, or another external device. These functional elements will be described below.

### [Reverberant Waveform Obtainer 41]

The reverberant waveform obtainer 41 obtains a reverberant waveform from each of the nozzles 23 of the ink heads 22 included in the ink ejection device 20 through the signal switcher 25 included in each of the ink heads 22 of the ink ejection device 20. Here, the reverberant waveforms obtained by the reverberant waveform obtainer 41 will be described.

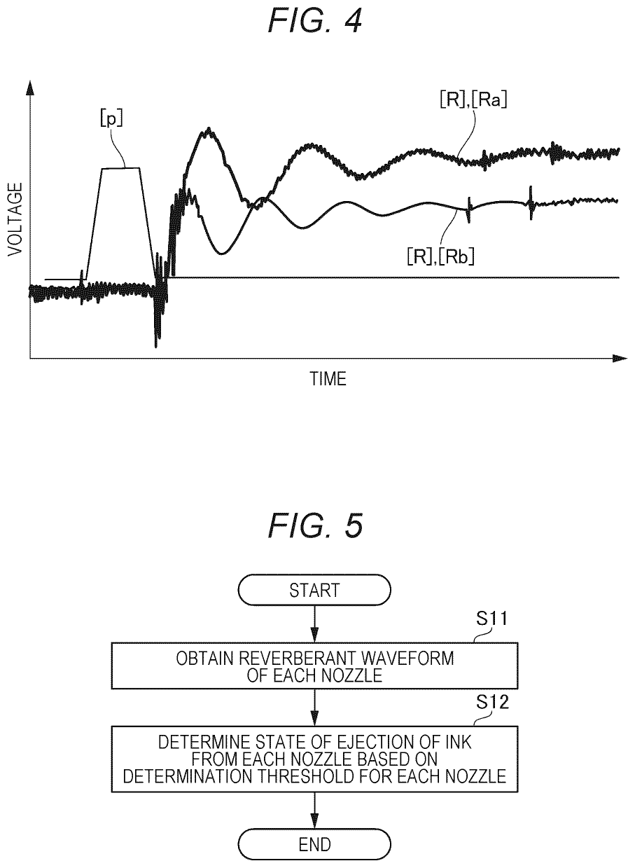

FIG. 4 is a diagram illustrating a reverberant waveform [R] when a pulse wave [p] is applied to a nozzle. As illustrated in FIG. 4, the reverberant waveform [R] is a waveform in which, when the pulse wave [p] is applied to the nozzle 23 from the pulse driver 24 (see FIG. 3), residual vibration generated in the nozzle immediately thereafter is grasped as a voltage waveform. The reverberant waveform [R] has a waveform that varies depending on the state of ejection of ink from the nozzle. That is, a normal waveform [Ra] obtained from a normal nozzle whose state of ejection of ink is normal and an abnormal waveform [Rb] obtained from an ink non-ejection nozzle whose state of ejection of ink is abnormal have different feature values, such as amplitudes, periods, bias levels (average biases), attenuation rates, and phases, from those of the normal nozzle.

### [Determination Threshold Keeper 42]

Referring back to FIG. 3, the determination threshold keeper 42 holds determination thresholds for determining the states of ejection of ink from the respective nozzles 23a, 23b, 23c, and . . . based on reverberant waveforms. The determination threshold keeper 42 holds the determination thresholds individually set for the nozzles 23a, 23b, 23c, and . . . . Each of the determination thresholds is a value set for at least one of the amplitude, the period, the bias level (average bias), the attenuation rate, and the phase, which are the feature values of each of the reverberant waveforms [R] obtained from the signal switchers 25.

Each of the determination thresholds is assumed to be a preset initial value, a value obtained by correcting the initial value in the threshold set controller 44 to be described next, or a value obtained by further correcting the value corrected in the threshold set controller 44 in the threshold set controller 44. A procedure for setting the initial values of the determination thresholds held in the determination threshold keeper 42 will be described in detail later in description of an ink ejection inspection method.

### [Reverberant Waveform Determinator 43]

The reverberant waveform determinator 43 compares the feature value indicated by the reverberant waveform [R] of each nozzle 23 obtained by the reverberant waveform obtainer 41 with the determination threshold for each nozzle held in the determination threshold keeper 42 to individually determine the state of ejection of ink for each nozzle.

The determination of the states of ejection of ink by the reverberant waveform determinator 43 is, for example, determination as to whether each nozzle is a normal nozzle that normally ejects ink or a defective nozzle whose state of ejection of ink is not normal. For example, in a case where each of the feature values such as the amplitude and the period is within a range of a determination threshold set for each feature value, the reverberant waveform determinator 43 determines that the nozzle is a normal nozzle which normally ejects ink. In other cases, the reverberant waveform determinator 43 determines that the nozzle is a defective nozzle whose state of ejection of ink is not normal. In addition, the defective nozzle may be in a state in which ink is not ejected from the nozzle or in a state in which ink is ejected from the nozzle but the amount of the ink ejected from the nozzle is abnormal. In addition, when the state of ejection of ink is determined, the reverberant waveform determinator 43 may not only determine whether the nozzle is a normal nozzle or a defective nozzle, but also determine whether the defective nozzle is an ink non-ejection nozzle or an abnormal ejection amount nozzle.

### [Threshold Set Controller 44]

The threshold set controller 44 sets, based on results of ink ejection of the nozzles, the determination thresholds for the reverberant waveforms [R] of the nozzles 23 obtained by the reverberant waveform obtainer 41, and causes the determination threshold keeper 42 to hold the set determination thresholds.

Further, the threshold set controller 44 corrects the determination threshold provided for each nozzle determined and extracted as a non-matching nozzle by the determination result collator 47 described below. Furthermore, the threshold set controller 44 updates the determination threshold for each non-matching nozzle held in the determination threshold keeper 42 to the corrected value. The setting and correction of the determination threshold by the threshold set controller 44 will be described in detail later in the description of the ink ejection inspection method.

### [Read Image Obtainer 45]

The read image obtainer 45 obtains image data of a read image read by the image reading device 30. The image data of the read image obtained by the read image obtainer 45 is data of a chart image to be formed as an ink ejection result of each nozzle. The timing of obtaining the image data by the read image obtainer 45 will be described in detail later in the description of the ink ejection inspection method.

### [Read Image Determinator 46]

The read image determinator 46 is provided as an example of an ink ejection result determinator, and determines the state of ejection of ink from each nozzle based on the image data obtained from the image reading device 30. Similarly to the determination by the reverberant waveform determinator 43, the determination of the states of ejection of ink by the read image determinator 46 is the identification of whether each nozzle is a normal nozzle or a defective nozzle, and the identification of whether the defective nozzle is an ink non-ejection nozzle or an abnormal ejection amount nozzle.

The ink ejection inspection device 40 may include an image determination result obtainer in place of the read image determinator 46. The image determination result obtainer obtains, for example, from the manipulator 50, the result of determining the state of ejection of ink from each nozzle based on the image read by the image reading device 30. In this case, a user may visually determine the state of ejection of ink from each nozzle.

### [Determination Result Collator 47]

The determination result collator 47 collates the determination result in the reverberant waveform determinator 43 with the determination result in the read image determinator 46 for each nozzle, and extracts, as a non-matching nozzle, a nozzle causing different determination results. In this case, the determination result collator 47 extracts each nozzle determined as a normal nozzle in the reverberant waveform determinator 43 and as a defective nozzle in the read image determinator 46, or extracts each nozzle determined as a defective nozzle in the reverberant waveform determinator 43 and as a normal nozzle in the read image determinator 46.

In addition, the determination result collator 47 determines whether or not the comparison has been performed a predetermined number of times for all the nozzles. In a case where the number of times that the comparison has been performed has not reached the predetermined number of times, the determination result collator 47 repeats the obtaining of a reverberant waveform and the extraction of a non-matching nozzle. The timing of the repetition by the determination result collator 47 will be described in detail later in the description of the ink ejection inspection method.

### [Input and Output Controller 48]

The input and output controller 48 drives the medium conveyance device 10 (see FIG. 1) and the ink ejection device 20 based on an instruction from the manipulator 50 to form the chart image held in the sheet conveyance device 10 on the recording medium 2. The input and output controller 48 also reads the chart image formed on the recording medium 2 by driving the image reading device 30. Furthermore, the input and output controller 48 drives the pulse driver 24 of the ink ejection device 20 to apply a test pulse to each of the nozzles 23, and causes the reverberant waveform determinator 43 to obtain reverberant waveforms at that time.

### <Manipulator 50>

The manipulator 50 inputs various instructions and settings related to image formation to be performed in the image forming apparatus 1. For example, an instruction to start an ink ejection inspection is input to the ink ejection device 20 from the manipulator 50, and initial values of the determination thresholds held in the determination threshold keeper 42 are input from the manipulator 50. Furthermore, the manipulator 50 may include a display part and may be configured to display an image read by the image reading device 30. Furthermore, the manipulator 50 may be an external device such as a personal computer or printer controller, which can perform communication for reception and transmission of data with a controller (not illustrated) of the image forming apparatus 1 or the ink ejection inspection device 40.

### <<Ink Ejection Inspection Method>>

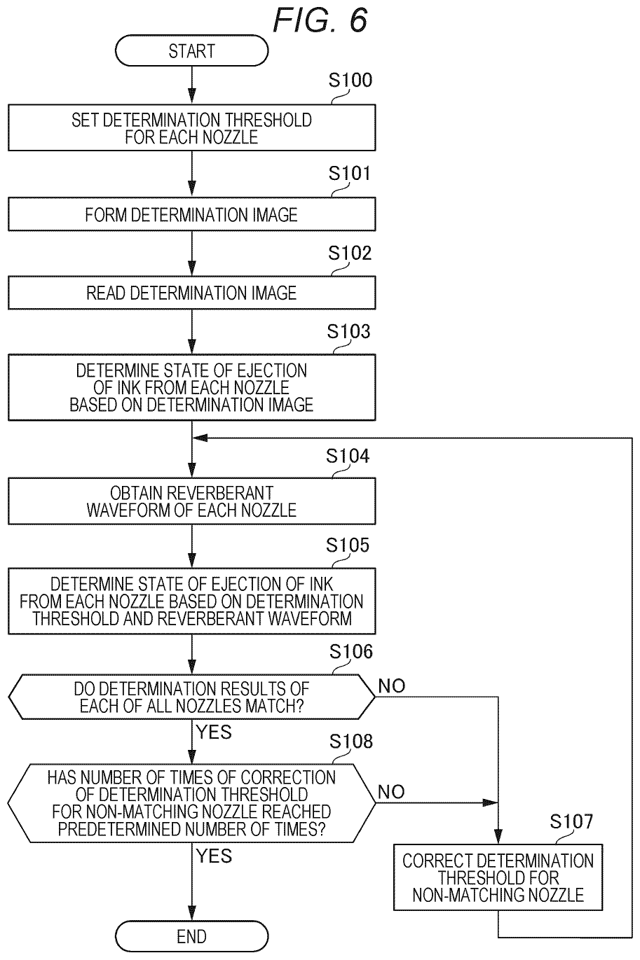

Next, the ink ejection inspection method according to the embodiment will be described. FIG. 5 and FIG. 6 are flowcharts (part 1) and (part 2) illustrating the ink ejection inspection method according to the embodiment, and illustrate a procedure performed when each functional element of the ink ejection inspection device 40 described above executes the ink ejection inspection program. Among these, FIG. 5 is a flowchart illustrating a procedure of ink ejection inspection, and FIG. 6 is a flowchart illustrating a procedure of correcting a determination threshold in the ink ejection inspection. The ink ejection inspection method according to the embodiment will be described below with reference to FIG. 1 to FIG. 4 in the order illustrated in the flowcharts of FIG. 5 and FIG. 6.

### <Procedure of Ink Ejection Inspection>

First, the procedure of the ink ejection inspection will be described with reference to FIG. 1 to FIG. 4 in the order illustrated in the flowchart of FIG. 5.

### [Step S11 (FIG. 5)]

In step S11, the input and output controller 48 causes the pulse driver 24 of the ink ejection device 20 to apply a test pulse to each nozzle 23 of each of the ink heads 22 included in the ink ejection device 20 based on an instruction to start the inspection from the manipulator 50. Thus, the reverberant waveform obtainer 41 obtains the reverberant waveform [R] of each of the nozzles 23.

In this case, the input and output controller 48 applies, to each of the nozzles 23, a test pulse that does not cause ink to be ejected in a state between image formations on recording media 2. The state between the image formations on the recording media 2 refers to, for example, a state where the ink ejection device 20 is located between the recording media 2 being conveyed by the medium conveyance device 10. Furthermore, even in a state where the ink ejection device 20 is located facing the recording medium 2, the input and output controller 48 may determine that a nozzle that is not forming an image by ink ejection is in the state between the image formations on the recording media 2, and apply a test pulse to the nozzle.

### [Step S12 (FIG. 5)]

In step S12, the reverberant waveform determinator 43 compares the feature value indicated by each reverberant waveform [R] of each nozzle 23 obtained in step S11 with the determination threshold for each nozzle held in the determination threshold keeper 42 to determine the state of ejection of ink from each nozzle individually. The determination of the state of ejection of ink from each nozzle 23 by the reverberant waveform determinator 43 is as described in the section for the reverberant waveform determinator 43.

The reverberant waveform determinator 43 outputs results of the determination to the manipulator 50. Accordingly, an operator of the image forming apparatus 1 can check the state of ejection of ink from each nozzle 23 of each of the ink heads 22 included in the ink ejection device 20 and repair a defective nozzle whose state of ejection of ink is not normal.

### <Procedure for Correcting Determination Threshold>

Next, a procedure for correcting a determination threshold in the ink ejection inspection in the order illustrated in the flowchart of FIG. 6 will be described with reference to FIG. 1 to FIG. 4.

### [Step S100 (FIG. 6)]

In step S100, the threshold set controller 44 sets, for the reverberant waveform [R] of each nozzle obtained by the reverberant waveform obtainer 41, the determination threshold for the feature value of the reverberant waveform [R] based on an instruction to set the determination threshold from the manipulator 50. The reverberant waveforms [R] are obtained in the same manner as the procedure described in step S11. The feature value of each reverberant waveform [R] for setting the determination threshold is at least one of the amplitude, the period, the bias level (average bias), the attenuation rate, and the phase.

Before the obtaining of the reverberant waveforms [R] for setting the determination thresholds, first, an initial defective nozzle detected by checking of a chart graphic is brought into a state where a function of the nozzle is recovered by cleaning, pressurization, or the like. In this state, the pulse driver 24 applies the same test pulse to each of the nozzles 23, and the reverberant waveform obtainer 41 obtains the reverberant waveform of each of the nozzles 23. Then, the threshold set controller 44 sets the initial value of the determination threshold for each of the obtained reverberant waveforms [R]. Thus, the determination threshold for each of the nozzles is set based on the reverberant waveform [R] of each of the nozzles in a state where the nozzles are determined to be normal based on the ink ejection results. The threshold set controller 44 stores the set determination threshold for each of the nozzles 23 to the determination threshold keeper 42.

The initial value of the determination threshold for each reverberant waveform [R] may be set outside the ink ejection inspection device 40. In this case, the initial values of the determination thresholds set outside are input to the ink ejection inspection device 40 from the manipulator 50 and are stored in the determination threshold keeper 42. Furthermore, each of the initial values of the determination thresholds may be set to a common default value for each of the nozzles.

### [Step S101]

In step S101, the input and output controller 48 causes the medium conveyance device 10 and the ink ejection device 20 to form a determination image, based on an instruction from the manipulator 50. The determination image formed in this case is a chart image for detecting a defective nozzle.

### [Step S102]

In step S102, the input and output controller 48 causes the image reading device 30 to read the determination image formed in step S101. Furthermore, the read image obtainer 45 obtains the determination image read by the image reading device 30.

### [Step S103]

In step S103, the read image determinator 46 individually determines the state of ejection of ink from each of the nozzles based on the determination image obtained by the read image obtainer 45. The determination of the state of ejection of ink from each of the nozzles by the read image determinator 46 is as described in the section for the read image determinator 46.

In addition, in a case where the ink ejection inspection device 40 includes an image determination result obtainer in place of the read image determinator 46, the above-described steps S101 to S103 are replaced with a step in which the result of identifying the state of ejection of ink from each of the nozzles from the outside is obtained from, for example, the manipulator 50. In this case, for example, the user may visually identify the state of ejection of ink from each of the nozzles based on the chart image for detecting a defective nozzle.

### [Step S104]

In step S104, the input and output controller 48 applies a test pulse to each of the nozzles 23 by controlling the pulse driver 24 of the ink ejection device 20, and causes the reverberant waveform obtainer 41 to obtain the reverberant waveform of each of the nozzles 23 generated at the time of applying the test pulse. In this case, the test pulse to be applied is the same as the test pulse in a case where the initial values of the determination thresholds are set (step S100) and the test pulse in the ink ejection inspection (step S11).

### [Step S105]

In step S105, the reverberant waveform determinator 43 individually determines the state of ejection of ink from each of the nozzles based on the reverberant waveform of each of the nozzles obtained in step S104 and the determination thresholds for each of the nozzles held by the determination threshold keeper 42. The determination of the state of ejection of ink from each of the nozzles by the reverberant waveform determinator 43 is as described in the section for the reverberant waveform determinator 43.

### [Step S106]

In step S106, the determination result collator 47 collates, for each of the nozzles, the determination result in the read image determinator 46 in step S103 with the determination result in the reverberant waveform determinator 43 in step S105, and determines whether or not the determination results of each of all the nozzles match each other. The process proceeds to step S108 in a case where the determination result collator 47 determines that the determination results of each of all of the nozzles match (YES), and proceeds to step S107 in other cases.

### [Step S107]

In step S107, the threshold set controller 44 corrects the determination threshold held in the determination threshold keeper 42 for each nozzle extracted as a non-matching nozzle causing different determination results in step S106.

For example, in the example illustrated in FIG. 4, the abnormal waveform [Rb] tends to have a smaller amplitude, a shorter period, and a lower average bias value than those of the normal waveform [Ra]. Therefore, for a nozzle determined as a normal nozzle by the reverberant waveform determinator 43 and determined as an ink non-ejection nozzle by the read image determinator 46, the threshold set controller 44 corrects the determination threshold by at least one of increasing the minimum threshold for the amplitude, increasing the minimum threshold for the period, and increasing the minimum threshold for the average bias value. For a nozzle determined as an ink non-ejection nozzle by the reverberant waveform determinator 43 and determined as a normal nozzle by the read image determinator 46, the threshold set controller 44 corrects the determination threshold by at least one of reducing the minimum threshold for the amplitude, reducing the minimum threshold for the period, and reducing the minimum threshold for the average bias value.

The threshold set controller 44 causes the determination threshold keeper 42 to overwrite and store the corrected determination threshold for each nozzle. Thereafter, the process returns to step S104 and the subsequent steps are repeated.

### [Step S108]

In step S108, the determination result collator 47 determines whether or not the number of times of correction of a determination threshold for a nozzle determined as a non-matching nozzle in step S106 reaches a predetermined number of times. In a case where the determination result collator 47 determines that the predetermined number of times has been reached (YES), the determination result collator 47 ends the process. On the other hand, in a case where the determination result collator 47 determines that the predetermined number of times has not been reached (NO), the process proceeds to step S107.

Even in a case where a nozzle determined as a non-matching nozzle in the first step S106 is not determined as a non-matching nozzle in step S106 performed in the subsequent repetition, the correction (changing) of the determination threshold is repeatedly performed the predetermined number of times in step S107.

In a case where determination thresholds are set for a plurality of different types of feature values, the threshold set controller 44 changes the determination thresholds for the different feature values in step S107 which is repeatedly performed the predetermined number of times. Accordingly, since the nozzle determined as a non-matching nozzle in the first step S106 is collated a plurality of times using the plurality of different types of determination thresholds, the accuracy of the determination thresholds is improved.

### Effects of Embodiment

According to the present embodiment described above, the state of ejection of ink from each nozzle 23 is determined based on the determination threshold individually set for the residual waveform of each nozzle 23, and thus the state of ejection of ink from each nozzle can be determined with high accuracy regardless of a variation in the capacity of each nozzle or a variation in elastic modulus, wiring impedance, and the like of the piezoelectric element provided in the nozzle.

Furthermore, the present embodiment is provided to correct the determination threshold individually set for each nozzle by collating the determination result of the state of ejection of ink based on the residual waveform of each nozzle and the determination result of the state of ejection of ink based on the chart image as the ink ejection result. Therefore, in the present embodiment, it is possible to correct the determination threshold for each nozzle with high accuracy based on the actual result of ink ejection from each nozzle. Thus, in the present embodiment, it is possible to determine the state of ejection of ink from each nozzle using the determination threshold highly accurately corrected for each nozzle, without depending on the above-described variations.

In addition, as described above, in the present embodiment, since it is possible to accurately determine the state of ejection of ink from each nozzle, a high-definition image can be formed by highly accurate ink ejection.

Note that the present invention is not limited to the above-described embodiment, and further includes various modification examples. For example, in the above-described embodiment, the image data of the chart image read by the image reading device 30 is exemplified as the ink ejection result of each nozzle. However, the ink ejection result of each nozzle may be a result obtained by directly detecting ejection of ink from each nozzle. In this case, a laser optical sensor that detects ejection of ink from each nozzle is provided in place of the image reading device 30. A result of detecting interruption of laser light emitted by a light emitting section of the optical sensor is taken as a result of ejection of ink from each nozzle.

Although embodiments of the present invention have been described and illustrated in detail, the disclosed embodiments are made for purposes of illustration and example only and not limitation. The scope of the present invention should be interpreted by terms of the appended claims. cm What is claimed is:

1. An ink ejection inspection device for inspecting a state of ejection of ink from a plurality of nozzles provided in an ink ejection device,
the ink ejection inspection device comprising a hardware processor that determines the state of ejection of ink from each of the nozzles by comparing a feature value indicated by a waveform of residual vibration obtained by applying a voltage to each of the nozzles with a determination threshold set for each of the nozzles.

2. The ink ejection inspection device according to claim 1, wherein the hardware processor holds the determination threshold set for each of the nozzles.

3. The ink ejection inspection device according to claim 1, wherein each of the nozzles is provided with a piezoelectric element that deforms in accordance with the applied voltage.

4. The ink ejection inspection device according to claim 1, wherein the hardware processor determines whether or not the state of ejection of ink from each of the nozzles is ink non-ejection.

5. The ink ejection inspection device according to claim 1, wherein the hardware processor sets the determination thresholds based on an ink ejection result of each of the nozzles.

6. The ink ejection inspection device according to claim 5, wherein the hardware processor corrects the determination threshold set for each of the nozzles based on the ink ejection result of each of the nozzles.

7. The ink ejection inspection device according to claim 6, wherein the hardware processor determines the state of ejection of ink from each of the nozzles based on the ink ejection result of each of the nozzles, collates, for each of the nozzles, a determination result obtained by comparison between the feature value and the determination threshold with a determination result based on the ink ejection result, and corrects the determination threshold for each of the nozzles based on a result of the collation.

8. The ink ejection inspection device according to claim 7, wherein the hardware processor corrects a determination threshold for a non-matching nozzle for which a determination result obtained by comparison between the feature value and the determination threshold does not match a determination result based on the ink ejection result, among the determination thresholds.

9. The ink ejection inspection device according to claim 5, wherein the ink ejection result of each of the nozzles corresponds to information obtained by reading an image formed by ink ejection from each of the nozzles with an image reading device.

10. The ink ejection inspection device according to claim 9, wherein the image is a chart image.

11. The ink ejection inspection device according to claim 5, wherein the ink ejection result of each of the nozzles corresponds to information indicating ejection of ink from each of the nozzles and obtained by detection of interruption of light by a laser optical sensor.

12. The ink ejection inspection device according to claim 5, wherein the ink ejection result of each of the nozzles corresponds to information obtained by visually observing an image formed by the ink ejection device.

13. The ink ejection inspection device according to claim 1, wherein each of the determination thresholds is a value set for at least one of an amplitude, a period, a bias level, an attenuation rate, and a phase of the waveform.

14. The ink ejection inspection device according to claim 7, wherein the hardware processor corrects, for each of the nozzles, the determination threshold by changing the determination threshold based on the result of the collation a plurality of times.

15. The ink ejection inspection device according to claim 7, wherein the hardware processor corrects, for each of the nozzles, the determination threshold by collating the determination results using a plurality of different types of determination thresholds a plurality of times.

16. An ink ejection inspection method for inspecting a state of ejection of ink from a plurality of nozzles provided in an ink ejection device,
the ink ejection inspection method comprising determining the state of ejection of ink from each of the nozzles by comparing a feature value indicated by a waveform of residual vibration obtained by applying a voltage to each of the nozzles with a determination threshold set for each of the nozzles.

17. A non-transitory recording medium storing a computer-readable ink ejection inspection program for causing a computer to determine a state of ejection of ink from a plurality of nozzles provided in an ink ejection device by comparing a feature value indicated by a waveform of residual vibration obtained by applying a voltage to each of the nozzles with a determination threshold set for each of the nozzles in order to inspect the state of ejection of ink from each of the nozzles.

18. An ink ejection device comprising the ink ejection inspection device according to claim 1.

19. An image forming apparatus comprising:
the ink ejection device according to claim 18; and
a medium conveyance device that conveys a recording medium, on which an image is formed by ink ejection by the ink ejection device, in a predetermined conveyance direction with respect to the ink ejection device.

20. The image forming apparatus according to claim 19, further comprising an image reader that is arranged on a downstream side in the conveyance direction with respect to the ink ejection device and reads the image formed on the recording medium, wherein
the hardware processor of the ink ejection inspection device included in the ink ejection device determines the state of ejection of ink from each of the nozzles of the ink ejection device based on the image read by the image reader, and
the hardware processor of the ink ejection inspection device corrects, for each of the nozzles, the determination threshold for determining the state of ejection of ink from each of the nozzles based on a determination result obtained by comparison between the feature value and the determination threshold and a determination result based on the ink ejection result.
